(19) United States
(12) Patent Application Publication
(10) Pub. No.: US 2026/0109027 A1
(43) Pub. Date: Apr. 23, 2026

(54) ACTUATOR AND ACTUATOR DESIGN METHODOLOGY

(71) Applicant: Tesla, Inc., Austin, TX (US)

(72) Inventors: Georgios VAMVAKAS, Austin, TX (US); Konstantinos LASKARIS, Austin, TX (US)

(21) Appl. No.: 19/117,255

(22) PCT Filed: Sep. 28, 2023
(86) PCT No.: PCT/US2023/034009

§ 371 Date: Mar. 31, 2025

Related U.S. Application Data
(60) Provisional application No. 63/378,000, filed on Sep. 30, 2022.

(51) Int. Cl. B25J 9/12; B25J 13/00; B25J 13/08; B25J 19/00

(52) U.S. Cl. CPC B25J 9/123; B25J 9/126; B25J 13/006; B25J 13/08; B25J 19/005

(57) ABSTRACT

A system or methodology of controlling movement of a robot (600) using actuators, the system can include one or more first type of actuators (1002) positioned at torso, shoulder, and hip locations of the robot; one or more second type of actuators (1004) positioned at wrist locations of the robot; one or more third type of actuators (1006) positioned at the wrist locations of the robot; one or more fourth type of actuators (1008) positioned at elbow and ankle locations of the robot; one or more fifth type of actuators (1010) positioned at the torso location and the hip locations of the robot; and one or more sixth type of actuators (1012) positioned at knee locations and the hip locations of the robot.

### CROSS-REFERENCE TO RELATED APPLICATIONS

This application claims the benefit of U.S. Provisional Ser. No. 63/378,000, filed Sep. 30, 2022, the entire contents of which is incorporated by reference in its entirety and for all purposes.

### BACKGROUND

### TECHNICAL FIELD

The present disclosure relates to robots, and more particularly, to actuator design and methodology.

### DESCRIPTION OF RELATED ART

Neural networks are relied upon for disparate uses and are increasingly forming the underpinnings of technology. For example, a neural network may be leveraged to perform object classification on an image obtained via a user device (e.g., a smart phone) or camera system. In this example, the neural network may represent a convolutional neural network which applies convolutional layers, pooling layers, and one or more fully connected layers to classify objects depicted in the image.

Complex neural networks are additionally being used to enable autonomous or semi-autonomous driving functionality for vehicles and things. For example, an unmanned aerial vehicle may leverage a neural network, in part, to enable navigation about a real-world area. In this example, the unmanned aerial vehicle may leverage sensors to detect upcoming objects and navigate around the objects. As another example, a robot may execute neural network(s) to navigate about a real-world area. A leg or arm of the robot may be formed from a plurality of connectors or members. A motion of each member can contribute to the navigation of the robot about a real-world area and can be independently controlled by one or more actuators. The design and features of these actuators can impact the performance characteristics of the robot.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### SUMMARY

An aspect is directed to a system of movement control of a robot using actuators, the system can include one or more first type of actuators positioned at torso, shoulder, and hip locations of the robot; one or more second type of actuators positioned at wrist locations of the robot; one or more third type of actuators positioned at the wrist locations of the robot; one or more fourth type of actuators positioned at elbow and ankle locations of the robot; one or more fifth type of actuators positioned at the torso location and the hip locations of the robot; and one or more sixth type of actuators positioned at knee locations and the hip locations of the robot.

A variation of the aspect above further includes one or more motors configured to cause movement of the one or more actuators.

A variation of the aspect above further includes one or more batteries positioned at the torso location of the robot and connected to the one or more motors.

A variation of the aspect above further includes a communication backbone communicatively connected to the one or more actuators and the one or more motors.

A variation of the aspect above further includes a processor communicatively connected to the communication backbone.

A variation of the aspect above is, wherein the one or more batteries are connected to the communication backbone.

A variation of the aspect above is, wherein the communication backbone is configured to allow communication between the processor, the motor, and sensors on the actuators.

A variation of the aspect above is, wherein the processor is configured to control the one or more motors and receive information from the sensors on the actuators through the communication backbone.

A variation of the aspect above is, wherein one or more of the first type, the second type, the third type, the fourth type, the fifth type, and the sixth type of actuators comprises rotary actuators.

A variation of the aspect above is, wherein at least one of the rotary actuators comprises a mechanical latch.

A variation of the aspect above is, wherein one or more of the first type, the second type, the third type, the fourth type, the fifth type, and the sixth type of actuators comprises linear actuators.

A variation of the aspect above is, wherein at least one of the linear actuators comprises planetary rollers.

Another aspect is directed to a method of controlling movement of a robot using actuators, the method can include controlling torso, shoulder, and hip locations of the robot with one or more first type of actuators; controlling wrist locations of the robot with one or more second type of actuators; controlling the wrist locations of the robot with one or more third type of actuators; controlling elbow and ankle locations of the robot with one or more fourth type of actuators; controlling the torso location and the hip locations of the robot with one or more fifth type of actuators; and controlling knee locations and the hip locations of the robot with one or more sixth type of actuators.

A variation of the aspect above further includes controlling the one or more actuators with one or more motors.

A variation of the aspect above further includes providing power to the one or more motors with one or more batteries positioned at the torso location of the robot.

A variation of the aspect above further includes communicatively connecting the one or more actuators and the one or more motors with a communication backbone.

A variation of the aspect above further includes communicatively connecting the communication backbone to a processor.

A variation of the aspect above further includes providing power to the communication backbone with the one or more batteries.

A variation of the aspect above further includes controlling the one or more motors and receiving information from the sensors on the actuators with the processor through the communication backbone.

A variation of the aspect above is, wherein one or more of the first type, the second type, the third type, the fourth type, the fifth type, and the sixth type of actuators comprises rotary actuators; and wherein one or more of the first type, the second type, the third type, the fourth type, the fifth type, and the sixth type of actuators comprises linear actuators.

### BRIEF DESCRIPTION OF THE DRAWINGS

The present inventions are described with reference to the accompanying drawings, in which like reference characters reference like elements, and wherein:

FIG. 1A is a block diagram illustrating an example autonomous robot which includes a multitude of image sensors and an example processor system.

FIG. 1B is a block diagram illustrating the example processor system determining object/signal information based on received image information from the example image sensors.

FIG. 1C illustrates an example of the resulting degree of vision for the robot.

FIG. 2 is a block diagram of an example vision-based machine learning model which includes at least one processing network.

FIG. 3 is a block diagram of the processing network.

FIG. 4 is a block diagram of the modeling network.

FIG. 5A illustrates a block diagram of a robot.

FIG. 5B illustrates exemplary placement of a battery pack and actuators on a robot according to this disclosure.

FIG. 5C illustrates exemplary actuators that are implemented on the robot of FIG. 5B according to this disclosure.

FIG. 5D illustrates a battery pack integrated into a robot illustrating a vertically oriented battery back with protective coverings.

FIG. 5E illustrates internal components of an exemplary rotatory actuator according to this disclosure.

FIG. 5F illustrates internal components of an exemplary linear actuator according to this disclosure.

FIG. 5G illustrates other internal components of the rotatory actuator of FIG. 5E.

FIG. 5H illustrates other internal components of the linear actuator of FIG. 5F.

FIG. 5I illustrates other internal components of the rotatory actuator of FIG. 5E.

FIG. 5J illustrates other internal components of the linear actuator of FIG. 5F.

FIG. 6 illustrates targets and methodology for movement of an exemplary actuator (e.g., left hip yaw) illustrated in FIGS. 5B and 5C including actuator torque and speed.

FIG. 7 illustrates a single association between the targets and methodology illustrated in FIG. 6 with system cost and actuator mass.

FIG. 8 is similar to FIG. 7 but includes a plurality of associations for use to select an optimized design for the actuator,

FIG. 9 illustrates performance aspects related to the torque and speed for the movement of the actuator for the joint (e.g., left hip yaw) from FIG. 6.

FIG. 10 illustrates association between performance at each position of a robot and the corresponding actuator type implemented at each position of the robot.

### DETAILED DESCRIPTION

One or more aspects of the present application relate to enhanced techniques for autonomous or semi-autonomous (collectively referred to herein as autonomous) operation of machinery, generally referred to robot or robotic machinery. In one or more embodiments, robots may be configured or optimized to conduct one or more tasks typically implemented through human effort. In some applications, a robot may be humanoid in appearance to physically resemble, at least in part, humans or human efforts. In other applications, a robot may not be constrained with features that are humanoid in appearance.

Thus, the robot may navigate about a real-world environment using vision-based sensor information. As may be appreciated, humans are capable of navigating within various environments and performing detailed tasks using vision and a deep understanding of their real-world surroundings. For example, humans are capable of rapidly identifying objects (e.g., walls, boxes, machinery, tools, etc.) and using these objects to inform navigation/locomotion (e.g., walking, running, avoiding collisions, etc.) and performing manipulation tasks (e.g., picking up objects, using machinery/tools, moving between defined locations, etc.).

One or more aspects of the present application describe a vision-based machine learning model which relies upon increased software complexity to enable a reduction in sensor-based hardware complexity while enhancing accuracy. For example, only image sensors may be used in some embodiments. Through use of image sensors or visions systems, such as one or more cameras, the described model corresponds to improvements and refinements of vision-based robotic movement and task completion. As will be described, the machine learning model may obtain images from the image sensors and combine (e.g., stitch or fuse) the information included therein. For example, the information may be combined into a vector space which is then further processed by the machine learning model to extract objects, signals associated with the objects, and so on.

Furthermore, and as will be described, to limit occlusion of objects and ensure substantial range of visibility of objects, the information may be projected based on a common virtual camera or virtual perspective. By way of simplifying the explanation, the objects may be positioned in the vector space according to their position as would be seen by the common virtual camera. For example, the virtual camera may be set at a certain height above a robot having visions systems. In this example, the vector space may depict objects proximate to the robot as would be seen by a camera at that height (e.g., pointing forward or angled-forward). Another example technique may rely upon a birds-eye view of objects positioned about a robot. For example, the birds-eye view may view objects as would be positioned based on a virtual camera pointing downwards at a substantial height.

In some embodiments or scenarios, processing the actual image data or processed virtual camera image data may have limitations or deficiencies in identification of objects that may be in the path of travel. In some embodiments, the objects may not be fully detectable based on the underlying image data. For example, environmental conditions may cause the image data to be inconsistent or otherwise incomplete. In other aspects, the trained machine learned models may not be configured to detect specific objects, such as physical objects that may not have been the typical objects found in locomotion models (e.g., movement models) for the robot but may present some form of physical obstruction in a specific scenario. For example, temporary equipment or dynamic changing payloads may not be the type of object that a vision system would be trained to recognize.

Thus, in some embodiments the machine learning model described herein may be relied upon for detection, determination, identifying of objects or physical obstructions based on projection or mapping of the vision system data (real or virtual) into a three-dimensional model centered around a robot. Illustratively, the three-dimensional model corresponds to a representation of the physical space within a defined range of a robot that is subdivided into a grid of three-dimensional volumes (e.g., blocks). Such three-dimensional blocks may be individually referred to as voxels. One or more machine-learned models can then correspond to query of the visual information (e.g., the image space) to make a characterization of whether individual voxels in the grid of voxels are obstructed. Illustratively, the characterization of each voxel can be considered binary for purposes of the occupancy network. Additionally, in some embodiments, the three-dimensional model can associate attribute data or metric data, such as velocity, orientation, type, related objects, to individual voxels. Accordingly, the processing results for each analysis of image data relates to an occupancy network in which one or more surrounding areas are associated with a prediction/estimation of obstructions/objects. Such occupancy network processing results can be independent of additional vision system processing techniques in which individual objects may be detected and characterized from the vision system data.

The three-dimensional model and associated data may be referred to as an occupancy network. The occupancy network may be relied upon for detection, determination, identifying, and so on, of static objects. The outputs of the described model and the occupancy network may be used by, for example, a planning and/or navigation model or engine to effectuate autonomous or semi-autonomous locomotion or manipulation. Additional description related to the birds-eye view network is included in U.S. Patent Prov. App. No. 63/260439 which is hereby incorporated herein by reference. In such applications, one or more aspects can be applied in a context of a robot.

The machine learning model described herein may include disparate elements which, in some embodiments, may be end-to-end trained. As will be described, images from image sensors may be provided to respective backbone networks. In some embodiments, these backbone networks may be convolutional neural networks which output feature maps for use later in the network. A transformer network, such as a self-attention network, may receive the feature maps and transform the information into an output vector space. For example, the output vector space may be associated with a virtual camera at various heights. The processed vector space can then be mapped to the three-dimensional model resulting in an organization of one or more areas surrounding the robot. In one embodiment, the three-dimensional model corresponds to a grid of voxels (e.g., three-dimensional boxes) that cumulatively model an area surrounding the robot. Each voxel is characterized by a prediction or probability that the mapped image data depicts an object/obstruction (e.g., an occupancy of the individual voxel). Additionally, each voxel may be associated with additional semantic data, such as velocity data, grouping criteria, object type data, etc. The semantic data may be provided as part of the occupancy network. Still further, in some embodiments, individual voxel dimensions may be further refined, generally referred to as voxel offsets, to distinguish or remove potential objects/obstructions that may be depicted in the image data but do not present actual objects/obstructions utilized in navigational or operational controls. For example, voxels offsets or changes to individual voxel dimension can account for environmental objects (e.g., dirt in the road) that may be depicted in image data but would not be modeled as an obstruction the occupancy network.

Still further, in some other embodiments, the processing result (e.g., the occupancy network) can be further refined by utilizing historical information within an established time frame such that the occupancy network can be updated. In some embodiments, the update can identify potential discrepancies in occupancy data, such as inconsistencies in the characterization of occupancy or non-occupancy within the time frame. Such inconsistencies may be based on errors or limitations in the vision system data. In another aspect, the update can identify validations or verifications in the successive occupancy networks, such as to increase confidence values based on consistent processing results.

Therefore, the disclosed technology allows for enhancements to autonomous locomotion or manipulation models while reducing sensor-complexity. For example, other sensors (e.g., radar, Lidar, and so on) may be removed during operation of the robots described herein. As may be appreciated, radar may introduce faults during operation of robots which may lead to phantom objects being detected. Additionally, lidar may introduce errors in certain environmental conditions and lead to substantial manufacturing complexity in robots. Additionally, the additional detection systems may increase the power consumption of the robot, which may limit usefulness and functionality.

While description related to an autonomous robot's locomotion and manipulation is included herein, as may be appreciated the techniques may be applied to other autonomous machinery. For example, the machine learning model described herein may be used, in part, to autonomously operate unmanned ground vehicles, unmanned aerial vehicles, and so on. Additionally, reference to robots may, in some embodiments, is not limited to any particular type of environment, such construction environments, factories, commercial facilities, home facilities, public areas, safety and protection environments, and the like.

### Block Diagram—Robot Processing System

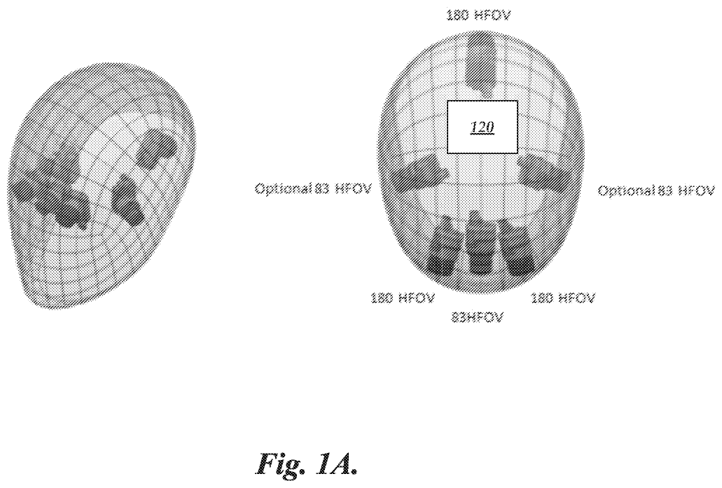

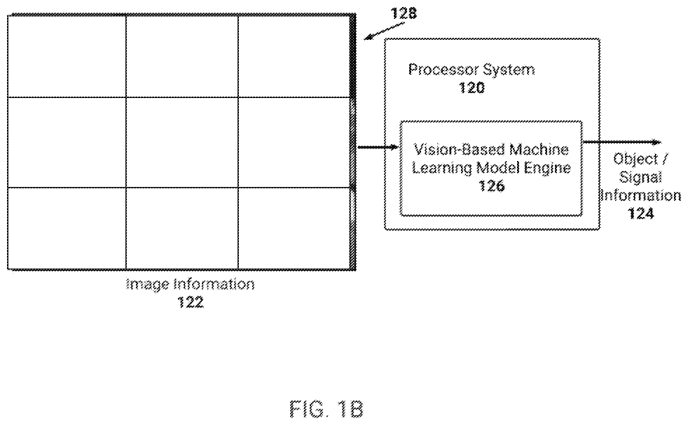

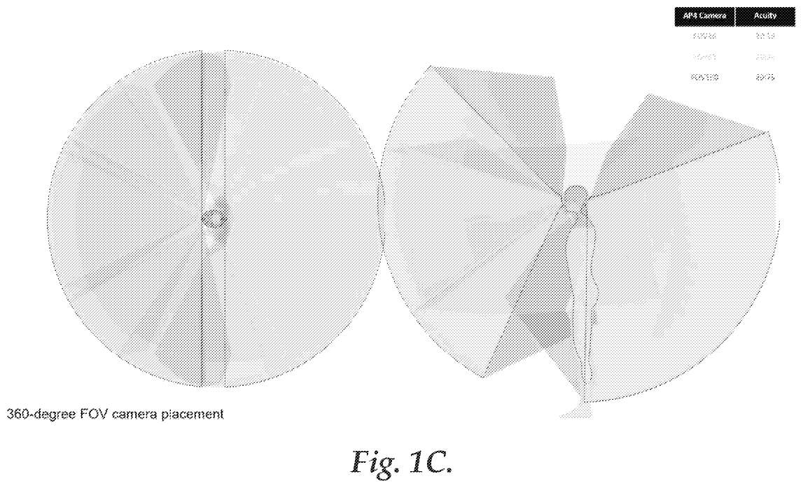

FIG. 1A is a block diagram illustrating an example autonomous robot 600 which includes a multitude of image sensors 102A-102F and an example processor system 120. The image sensors may include cameras which are positioned about the robot 600. For example, the cameras may allow for a substantially 360-degree view around the robot 600.

The image sensors may obtain images which are used by the processor system 120 to, at least, determine information associated with objects positioned proximate to the vehicle 100. The images may be obtained at a particular frequency, such as 30 Hz, 36 Hz, 60 Hz, 65 Hz, and so on. In some embodiments, certain image sensors may obtain images more rapidly than other image sensors. As will be described below, these images may be processed by the processor system 120 based on the vision-based machine learning model described herein. For purposes of illustration, the processing system 120 is illustrated as being located in the area of the robot 600 resembling a human head. However, such placement is simply illustrative in nature and is not required.

In one embodiment, a first image sensor A includes three image sensors which are laterally offset from each other. For example, the camera housing may include three image sensors which point forward. In this example, a first of the image sensors may have a wide-angled (e.g., fisheye) lens. A second of the image sensors may have a normal or standard lens (e.g., 35 mm equivalent focal length, 50 mm equivalent, and so on). A third of the image sensors may have a zoom or narrow-view lens. In this way, three images of varying focal lengths may be obtained in the forward direction by the robot 600.

A second image sensor may be side-facing or rear-facing and positioned on the left side of the robot 600. Similarly, a third image sensor may also be side-facing or rear-facing and positioned on the right side of the robot 600. A fourth image sensor may be positioned such that it points behind the robot 600 and obtains images in the rear direction of the robot 600 (e.g., assuming the robot 600 is moving forward).

While the illustrated embodiments include image sensors, as may be appreciated additional, or fewer, image sensors may be used and fall within the techniques described herein.

The processor system 120 may obtain images from the image sensors and detect objects, and signals associated with the objects, using the vision-based machine learning model described herein. Based on the objects, the processor system 120 may adjust one or more location or manipulation features or tasks. For example, the processor system 120 may cause the robot 600 to turn, slow down, implement pre-defined tasks, avoid collisions, select location paths, generate alerts, and so on. While not described herein, as may be appreciated the processor system 120 may execute one or more planning and/or navigation engines or models which use output from the vision-based machine learning model to effectuate autonomous driving.

In some embodiments, the processor system 120 may include one or more matrix processors which are configured to rapidly process information associated with machine learning models. The processor system 120 may be used, in some embodiments, to perform convolutions associated with forward passes through a convolutional neural network. For example, input data and weight data may be convolved. The processor system 120 may include a multitude of multiply-accumulate units which perform the convolutions. As an example, the matrix processor may use input and weight data which has been organized or formatted to facilitate larger convolution operations.

For example, input data may be in the form of a three-dimensional matrix or tensor (e.g., two-dimensional data across multiple input channels). In this example, the output data may be across multiple output channels. The processor system 120 may thus process larger input data by merging, or flattening, each two-dimensional output channel into a vector such that the entire, or a substantial portion thereof, channel may be processed by the processor system 120. As another example, data may be efficiently re-used such that weight data may be shared across convolutions. With respect to an output channel, the weight data 106 may represent weight data (e.g., kernels) used to compute that output channel.

Additional example description of the processor system, which may use one or more matrix processors, is included in U.S. Pat. No. 11,157,287, U.S. Pat. No. 11,409,692, and U.S. Pat. No. 11,157,441, which are hereby incorporated by reference in their entirety and form part of this disclosure as if set forth herein.

FIG. 1B is a block diagram illustrating the example processor system 120 determining object/signal information 124 based on received image information 122 from the example image sensors.

The image information 122 includes images from image sensors positioned about a robot (e.g., robot 600). In the illustrated example of FIG. 1A, there are 8 image sensors and thus 8 images are represented in FIG. 1B. For example, a top row of the image information 122 includes three images from the forward-facing image sensors. As described above, the image information 122 may be received at a particular frequency such that the illustrated images represent a particular time stamp of images. In some embodiments, the image information 122 may represent high dynamic range (HDR) images. For example, different exposures may be combined to form the HDR images. As another example, the images from the image sensors may be pre-processed to convert them into HDR images (e.g., using a machine learning model).

In some embodiments, each image sensor may obtain multiple exposures each with a different shutter speed or integration time. For example, the different integration times may be greater than a threshold time difference apart. In this example, there may be three integration times which are, in some embodiments, about an order of magnitude apart in time. The processor system 120, or a different processor, may select one of the exposures based on measures of clipping associated with images. In some embodiments, the processor system 120, or a different processor may form an image based on a combination of the multiple exposures. For example, each pixel of the formed image may be selected from one of the multiple exposures based on the pixel not including values (e.g., red, green, blue) values which are clipped (e.g., exceed a threshold pixel value).

The processor system 120 may execute a vision-based machine learning model engine 126 to process the image information 122. An example of the vision-based machine learning model is described in more detail below. As described herein, the vision-based machine learning model may combine information included in the images. For example, each image may be provided to a particular backbone network. In some embodiments, the backbone networks may represent convolutional neural networks. Outputs of these backbone networks may then, in some embodiments, be combined (e.g., formed into a tensor) or may be provided as separate tensors to one or more further portions of the model. In some embodiments, an attention network (e.g., cross-attention) may receive the combination or may receive input tensors associated with each image sensor. The combined output, as will be described, may then be provided for analysis, illustratively, a determination of object detection within the processed image data.

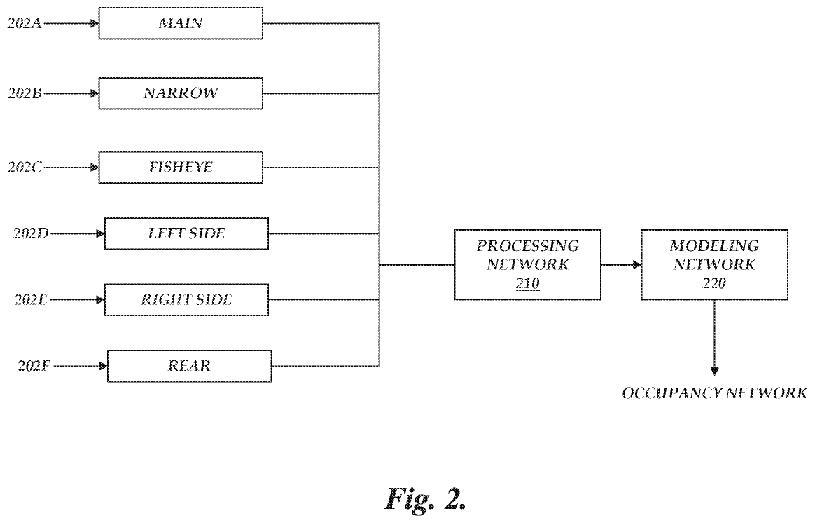

As illustrated in FIG. 1B, the vision-based machine learning model engine 126 may output object/signal information 124. This information 124 may represent information identifying objects depicted in the image information 122. For example, the information 122 may include one or more of positions of the objects (e.g., information associated with cuboids about the objects), velocities of the objects, accelerations of the objects, types or classifications of the objects, whether a car object has its door open, and so on. Examples of the object/signal information 124 are described below, with respect to FIG. 2.

With respect to cuboids, example information 122 may include location information (e.g., with respect to a common virtual space or vector space), size information, shape information, and so on. For example, the cuboids may be three-dimensional. Example information 122 may further include whether an object is crossing into an intended path of travel for the robot 600. An example of the resulting degree of vision for the robot 600 is illustrated in exemplary form in FIG. 1C.

Additionally, and as will be described, the vision-based machine learning model engine 126 may process multiple images spread across time. For example, video modules may be used to analyze images (e.g., the feature maps produced thereof, for example by the backbone networks or subsequently in the vision-based machine learning model) which are selected from within a prior threshold amount of time (e.g., 3 seconds, 5 seconds, 15 seconds, an adjustable amount of time, and so on). In this way, objects may be tracked over time such that the processor system 120 monitors their location even when temporarily occluded.

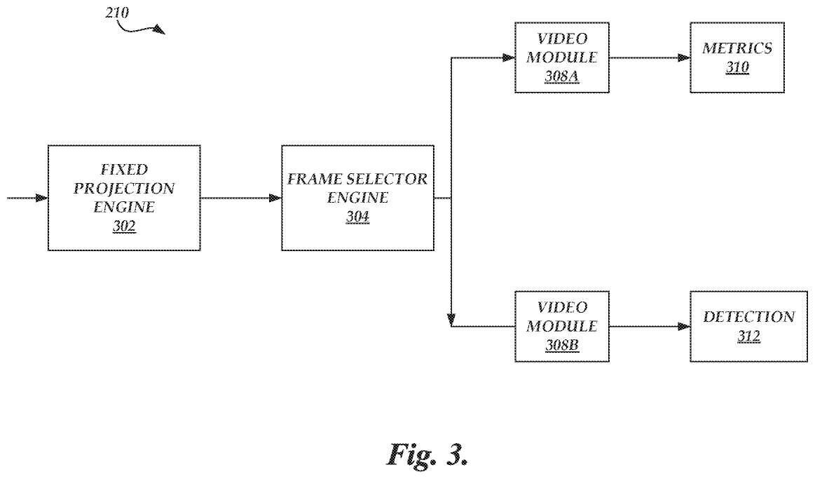

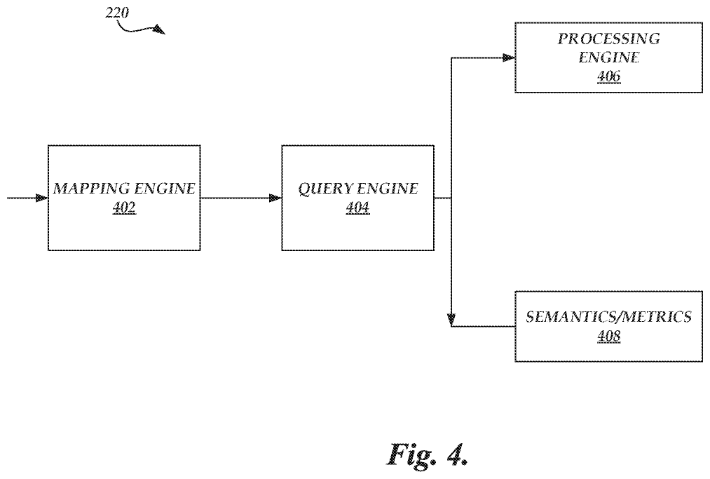

In some embodiments, the vision-based machine learning model engine 126 may output information which forms one or more images. Each image may encode particular information, such as locations of objects. For example, bounding boxes of objects positioned about an autonomous robot may be formed into an image. In some embodiments, the projections 322 and 422 of FIGS. 3B and 4B may be images generated by the vision-based machine learning model.

FIG. 2 is a block diagram of an example vision-based machine learning model which includes at least one processing network 210. The example model may be executed by an autonomous robot, such as a robot 600. Thus, actions of the model may be understood to be performed by a processor system (e.g., system 120) included in the robot 600.

In the illustrated example, images 202A-202F are received by the vision-based machine learning model. These images 202A-202F may be obtained from image sensors positioned about the robot, such as image sensors in FIG. 1A. The vision-based machine learning model includes backbone networks 200 which receive respective images as input. Thus, the backbone networks 200 process the raw pixels included in the images 202A-202F. In some embodiments, the backbone networks 200 may be convolutional neural networks. For example, there may be 5, 10, 15, and so on, convolutional layers in each backbone network.

In some embodiments, the backbone networks 200 may include residual blocks, recurrent neural network-regulated residual networks, and so on. Additionally, the backbone networks 200 may include weighted bi-directional feature pyramid networks (BiFPN). Output of the BiFPNs may represent multi-scale features determined based on the images 202A-202H. In some embodiments, Gaussian blur may be applied to portions of the images at training and/or inference time. For example, road edges may be peaky in that they are sharply defined in images. In this example, a Gaussian blur may be applied to the road edges to allow for bleeding of visual information such that they may be detectable by a convolutional neural network.

Additionally, certain of the backbone networks 200 may pre-process the images such as performing rectification, cropping, and so on. With respect to cropping, images 202C from the fisheye forward-facing lens may be vertically cropped to remove certain elements included based on the curvature of the robot 600 (e.g., a curvature or protective mechanisms associated with the robot body).

With respect to rectification, the robot 600 described herein may be examples of robots which may be implemented in various environments and implementations. Due to tolerances in manufacturing and/or differences in use of the robot 600, the image sensors in the robots may be angled, or otherwise positioned, slightly differently (e.g., differences in roll, pitch, and/or yaw). Additionally, different models of robot 600 may execute the same vision-based machine learning model. These different models may have the image sensors positioned and/or angled differently. The vision-based machine learning model described herein may be trained, at least in part, using information aggregated from the robot fleets. Thus, differences in point of view of the images may be evident due to the slight distinctions between the angles, or positions, of the image sensors in the robot 600 included in the robot fleets.

Thus, rectification may be performed via the backbone networks 200 to address these differences. For example, a transformation (e.g., an affine transformation) may be applied to the images 202A-202F, or a portion thereof, to normalize the images. In this example, the transformation may be based on camera parameters associated with the image sensors (e.g., image sensors) such as extrinsic and/or intrinsic parameters. In some embodiments, the image sensors may undergo an initial, and optionally repeated, calibrated step. For example, as a robot conducts location or manipulation tasks the cameras may be calibrated to ascertain camera parameters which may be used in the rectification process. In this example, specific markings (e.g., path symbols) may be used to inform the calibration. The rectification may optionally represent one or more layers of the backbone networks 200, in which values for the transformation are learned based on training data.

The backbone networks 200 may thus output feature maps (e.g., tensors) which are used by the processing network 210. In some embodiments, the output from the backbone networks 200 may be combined into a matrix or tensor. In some embodiments, the output may be provided as a multitude of tensors (e.g., 8 tensors in the illustrated example) to the processing network 210. In the illustrated example, the output is referred to as vision information 204 which is input into the networks 210.

The output tensors from the backbone networks 200 may be combined (e.g., fused) together into respective virtual camera spaces (e.g., a vector space) via the processing network 210. The image sensors positioned about the robot 600 may be at different heights of the robot. For example, the left and right image sensors may be positioned higher than the front and rear image sensors. Thus, to allow for a consistent view of objects positioned about the robot 600, the virtual camera space may be used. As described above, the processing network 210 may use or more virtual camera spaces.

For certain information determined by the vision-based machine learning model, the autonomous robot's kinematic information 206 may be used. Example kinematic information 206 may include the robot 600 velocity, acceleration, yaw rate, and so on. In some embodiments, the images 202A-202F may be associated with kinematic information 206 determined for a time, or similar time, at which the images 202A-202F were obtained. For example, the kinematic information 206, such as velocity, yaw rate, acceleration, may be encoded (e.g., embedded into latent space), and associated with the images.

With respect to determining velocity of one or more objects, such as a robot, the vision-based machine learning model may thus use the autonomous robot's own velocity when determining the object's relative velocity. In addition, the processing network 210 may process images at a particular frame rate. Thus, sequential images may be obtained which are at a same, or substantially same, time delt apart. Based on this information, the processing network 210 may be trained to estimate the relative velocity of objects.

Example output from the processing network 210 may represent information associated with objects, such as location (e.g., position with a virtual camera space), depth, and so on. For example, the information may relate to cuboids associated with objects positioned about the robot 600. The output may also represent signals which are utilized by the processor system to autonomous drive the robot 600. Example signals may include an indication of portions of the processed vision signals can be characterized as depicting an object or not an object.

The output may be generated via a forward pass through the networks 210. In some embodiments, forward passes may be computed at a particular frequency (e.g., 24 Hz, 30 Hz, and so on). In some embodiments, the output may be used, for example, via a planning engine. As an example, the planning engine may determine driving actions to be performed by the autonomous robot (e.g., accelerations, turns, braking, and so on) based on the periscope and panoramic views of the real-world environment.

As further shown in FIG. 2, the output of the processing network will be utilized as inputs to the modeling network 220. The output of the modeling network 220 can then correspond to processing results corresponding to a modeled occupancy network. As previously discussed, the modeled occupancy network corresponds to a mapped three-dimensional model resulting in an organization of one or more areas surrounding the robot. In one embodiment, the three-dimensional model corresponds to a grid of voxels (e.g., three-dimensional boxes) that cumulatively model an area surrounding the robot 600. Each voxel is characterized by a prediction or probability that the mapped image data depicts an object/obstruction (e.g., an occupancy of the individual voxel). Additionally, each voxel may be associated with additional semantic data, such as velocity data, grouping criteria, object type data, etc. The semantic data may be provided as part of the occupancy network. Still further, in some embodiments, individual voxel dimensions may be further refined, generally referred to as voxel offsets, to distinguish or remove potential objects/obstructions that may be depicted in the image data but do not present actual objects/obstructions utilized in navigational or operational controls. For example, voxels offsets or changes to individual voxel dimension can account for environmental objects (e.g., dirt in the manufacturing location) that may be depicted in image data but would not be modeled as an obstruction the occupancy network.

Still further, in some other embodiments, the processing result (e.g., the occupancy network) can be further refined by utilizing historical information within an established time frame such that the occupancy network can be updated. In some embodiments, the update can identify potential discrepancies in occupancy data, such as inconsistencies in the characterization of occupancy or non-occupancy within the time frame. Such inconsistencies may be based on errors or limitations in the vision system data. In another aspect, the update can identify validations or verifications in the successive occupancy networks, such as to increase confidence values based on consistent processing results.

FIG. 3 is a block diagram of the processing network 210. As described in FIG. 2, the processing network 210 may be used to generate vision image data from one or more cameras or visions systems. In the illustrated example, vision information 204 from the backbone networks (e.g., networks 200) is provided as input into a fixed projection engine 302.

The fixed projection engine 302 may project information into a virtual camera space associated with a virtual camera. As described above, the virtual camera may be positioned at 1 meter, 1.5 meters, 2.5 meters, and so on, above an autonomous robot executing the vision-based machine learning model. Without being constrained by way of theory, it may be appreciated that pixels of input images may be mapped into the virtual camera space. For example, a lookup table may be used in combination with extrinsic and intrinsic camera parameters associated with the image sensors (e.g., image sensors in FIG. 1A).

As an example, each pixel may be associated with a depth in the virtual camera space. Each pixel may represent a ray out of an image, with the ray extending in the virtual camera space. For a given pixel, a depth may be assumed or otherwise identified. With respect to the ray, the fixed projection engine 302 may identify two different depths along the ray from the given pixel. In some embodiments, these depths may be at 5 meters and at 50 meters. In other embodiments, the depths may be at 3 meters, 7 meters, 45 meters, 52 meters, and so on. The processor system 120 may then form the virtual camera space based on combinations of these rays for the pixels of the images. As may be appreciated, the position of a pixel in an input image may substantially correspond with a position in a tensor or tensors which form the vision information 204.

In some embodiments, the vector space may be warped by the processing network 210 such that portions of the three-dimensional vector space are enlarged. For example, objects depicted in a view of a real-world environment as seen by a camera positioned at 1.5 meters, 2 meters, and so on may be warped by the processing network 210. The vector space may be warped such that portions of interest may be enlarged or otherwise made more prominent. For example, the width dimension and height dimension may be warped to elongate objects. To effectuate this warping, training data may be used where the labeled output is object positions which have been adjusted according to the warping. Additionally, the fixed projection engine 302 may warp, for example, the height dimension to ensure that objects are enlarged according to at least one dimension.

Output from the fixed projection engine 302 is provided as input to the frame selector engine 304. To ensure that objects are able to be tracked through time, even while temporarily occluded, the vision-based machine learning model can utilize a multitude of frames during a forward pass through the model. For example, each frame may be associated with a time, or short range of times, at which the image sensors are triggered to obtain images. Thus, the frame selector engine 304 may select vision information 204 which corresponds to images taken at different times within a prior threshold amount of time.

For example, the vision information 204 may be output by the processor system 120 at a particular frame rate (e.g., 20 Hz, 24 Hz, 30 Hz), The vision information 204, subsequent to the fixed projection engine 302, may then be queued or otherwise stored by the processor system 120. For example, the vision information 204 may be temporally indexed. Thus, the frame selector engine 304 may obtain vision information from the queue or other data storage element. In some embodiments, the frame selector engine 304 may obtain 12, 14, 16, and so on, frames (e.g., vision information associated with 12, 14, or 16-time stamps at which images were taken) spread over the previous 3, 5, 7, 9, seconds. In some embodiments, these frames may be evenly spaced part in time over the previous time period. While description of frames is included herein, as may be appreciated the feature maps associated with image frames taken at a particular time, or within short range of times, may be selected by the frame selector engine 304.

Output from the frame selector engine 304 may, in some embodiments, represent a combination of the above-described frames 306A-N. For example, the output may be combined to form a tensor which is then processed by the remainder of the processing network 210.

For example, the output 306A-N (temporally indexed features). may be provided to a multitude of video modules. In the illustrated example, two video modules 308A-308B are used. The video modules 308A-308B may represent convolutional neural networks, which may cause the processor system 120 to perform three-dimensional convolutions. For example, the convolutions may cause mixing of space and time dimensions. In this way, the video modules 308A-308B may allow for tracking of movement and objects over times. In some embodiments, the video modules may represent attention networks (e.g., spatial attention).

With respect to video module 308A, kinematic information 206 associated with the autonomous robot executing the vision-based machine learning model may be input into the module 308A. As described above, the kinematic information 206 may represent one or more of acceleration, velocity, yaw rate, turning information, braking information, and so on. The kinematic information 206 may additionally be associated with each of the frames 306A-N selected by the frame selector engine 304. Thus, the video module 308A may encode this kinematic information 206 for use in determining, as an example, velocity of objects about the robot 600. With respect to the processing network 210, the velocity may represent allocentric velocity.

The processing network 210 includes heads 310, 312, to determine different information associated with objects. For example, head 310 may determine velocity associated with objects while head 312 may determine position information and so on as illustrated in FIG. 2.

In general, the vision-based machine learning model described herein may include a multitude of trunks or heads. As known by those skilled in the art, these trunks or heads (collectively referred to herein as heads) may extend from a common portion of a neural network and be trained as experts in determining specific information. For example, a first head may be trained to output respective velocities of objects positioned about a robot. As another example, a second head may be trained to output particular signals which describe features, or information, associated with the objects. Example signals may include whether a nearby door is opened or ajar.

In addition to being experts in specific information, the separation into different heads allows for piecemeal training to quickly incorporate new training data. As new training information is obtained, portions of the machine learning model which would most benefit from the training information may be quickly updated. In this example, the training information may represent images or video clips of specific real-world scenarios gathered by robots in real-world operation. Thus, a particular head or heads may be trained, and the weights included in these portions of the network may be updated. For example, other portions (e.g., earlier portions of the network) may not have weights updated to reduce a training time and time to updating robot 600.

In some embodiments, training data which is directed to one or more of the heads may be adjusted to focus on those heads. For example, images may be masked (e.g., loss masked) such that only certain pixels of the images are supervised while otherwise are not supervised. In this example, certain pixels may be assigned a value of zero while other pixels may maintain their values or be assigned a value of one. Thus, if training images depict a rarely seen object (e.g., a relatively new form of object) or signal (e.g., a known object with an irregular shape) then the training images may optionally be masked to focus on that object or signal. During training, the error generated may be used to train for the loss in the pixels which a labeler has associated with the object or signal. Thus, only a head associated with this type of object or signal may be updated.

To ensure that sufficient training data is obtained, the robot 600 may optionally execute classifiers which are triggered to obtain images which satisfy certain conditions. For example, robots operated by end-users may automatically obtain training images which depict, for example, tire spray, rainy conditions, snow, fog, fire soke, and so on. Further description related to use of classifiers is described in U.S. Patent Pub. No. 2021/0271259 which is hereby incorporated herein by reference in its entirety as if set forth herein.

FIG. 4 is a block diagram of the modeling network 220. As described in FIG. 2, the modeling network 220 may be used to generation three-dimensional models from inputted vision information, such as processing network 210. The mapping engine 402 can be utilized to map feature data from the inputted image data and project the inputted data into the three-dimensional models. As described above, the modeled occupancy network corresponds to a mapped three-dimensional model resulting in an organization of one or more areas surrounding the robot. In one embodiment, the three-dimensional model corresponds to a grid of voxels (e.g., three-dimensional boxes) that cumulatively model an area surrounding the robot 600 Output from the mapping engine 402 is provided as input to the query engine 404. For each voxel in the grid of voxels, the query engine 404 illustratively queries the image data to determine whether an object/obstruction is depicted or detected in the image data. As previously described, the determination of an object or obstruction (e.g., occupancy) is a binary decision. For example, any portion of the voxel that is associated with an object/obstruction may indicate that the voxel is “occupied” regardless of whether the entire voxel is encompasses or fills the voxel.

Output from the query engine 404 may be provided to processing engine 406 for additional processing. In one aspect, the processing engine 406 can implement voxel offset or change in dimensions for the modeled grid. Illustratively, although the determination of voxel occupancy is considered binary, the processing engine 406 can be configured to adjust dimensions of individual voxels such that the occupancy network that is provided for navigational or control information may better approximate the details or contours of the objects or obstructions. This is opposed to a more geometric shaped approximation that would result if the voxel dimensions remain static. In another aspect, the processing engine 406 can also group sets of voxels or create semantics that may associate voxels characterized as being part of the same object. Illustratively, an object/obstruction may span multiple modeled voxel spaces such that each voxel is individually considered “occupied.” The model can further include organization information or type identifiers that allow command and control components to consider voxels associated with the same object for decision.

As further illustrated in FIG. 4, a metric engine can also receive and calculate various metrics or additional semantic data for each voxel. Such metric data or semantic data can include, but is not limited to, velocity, orientation, type, related objects, to individual voxels. Illustratively, the generation of the three-dimensional model does not need to distinguish between objects that are static in nature and objects that are dynamic in nature. Rather, for each time instance of vision data, the three-dimensional model can consider voxels as being occupied or not occupied. However, the command-and-control mechanisms may wish to under the kinematic nature of the object (e.g., static vs. dynamic). Accordingly, the occupancy network (which is independent of dynamic) can associate the voxel data with additional metrics/semantics that can facilitate the use of the occupancy network processing result.

Accordingly, the processing results for each analysis of image data relates to an occupancy network in which one or more surrounding areas are associated with a prediction/estimation of obstructions/objects. Such occupancy network processing results can be independent of additional vision system processing techniques in which individual objects may be detected and characterized from the vision system data.

### Robot Block Diagram and Architecture

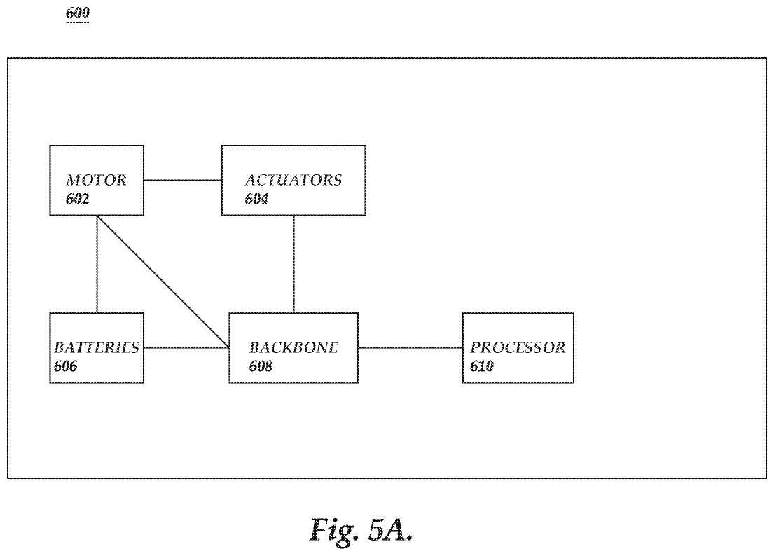

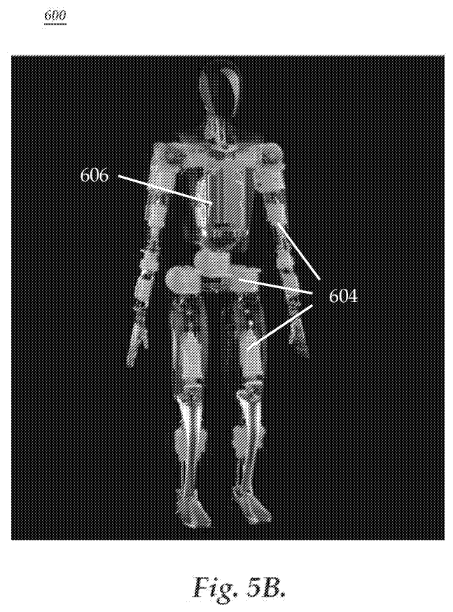

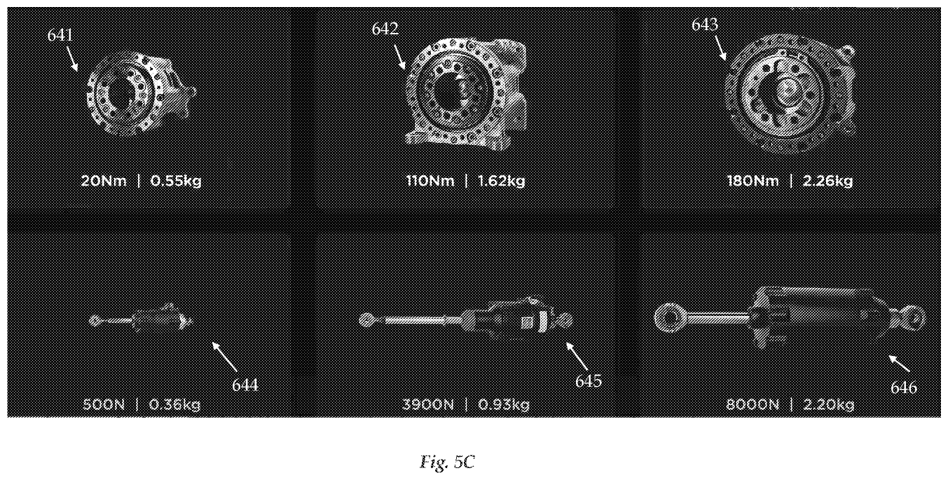

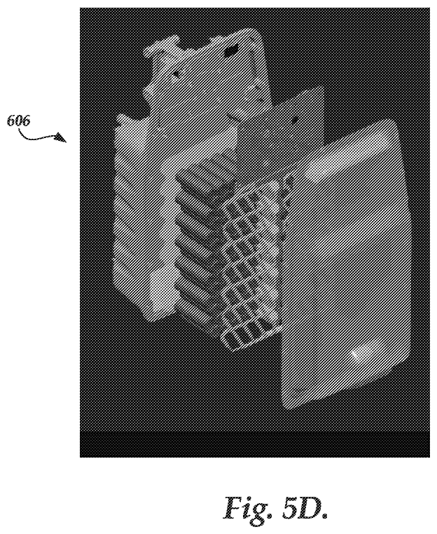

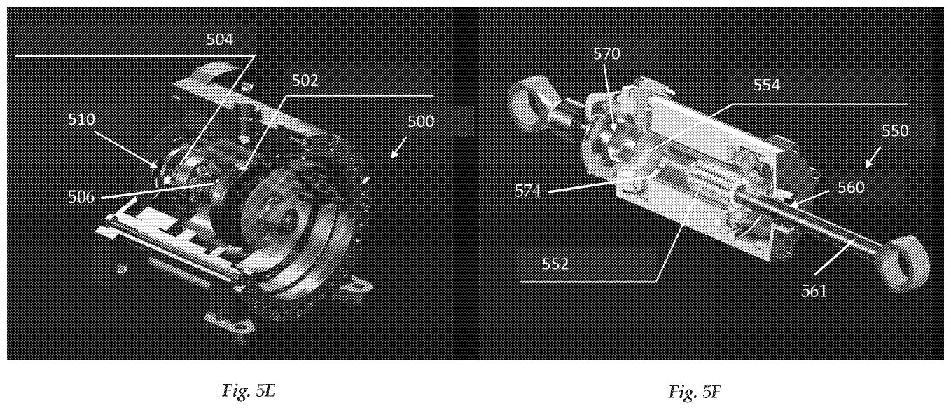

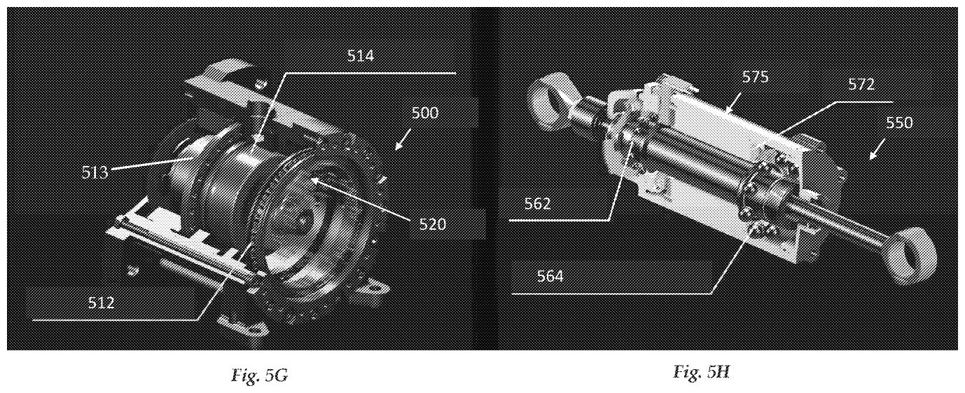

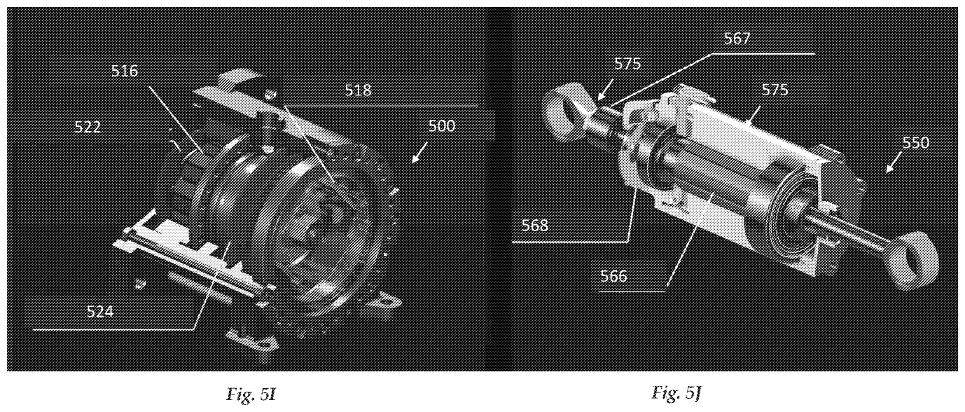

FIG. 5A illustrates a block diagram of a robot 600. The robot 600 may include one or more motors 602 which cause movement of one or more actuators or manipulation joints 604. The one or more actuators 604 can be associated with each joint of each appendage or limb of the robot 600. For example, in certain embodiments, each limb can comprise a plurality of joints or links with each joint comprising a plurality of actuators (e.g., one or more rotary actuators and one or more linear actuators). In certain embodiments, the one or more rotary actuators allow rotation of a link about a joint axis of an adjacent link. In certain embodiments, the one or more linear actuators allow a translation between links.

In certain embodiments, one or more limbs (e.g., arm, leg) each comprise a series of rotary actuators. In certain embodiments, a first rotary actuator is associated with a shoulder or hip, a second rotary actuator is associated with an elbow or knee, and a third rotary actuator is associated with a wrist or ankle. Of course more or less than three rotary actuators can be employed within a single limb and still fall within the scope of this disclosure.

In certain embodiments, the one or more limbs (e.g., arm, leg) further comprise a series of linear actuators. In certain embodiments, a first linear rotary actuator is associated with the shoulder or the hip, a second linear actuator is associated with the elbow or the knee, and the third linear actuator is associated with the wrist or the ankle. Of course more or less than three linear actuators can be employed within a single limb and still fall within the scope of this disclosure.

Illustrative examples of the actuators or manipulation joints 604 are shown in FIGS. 5B and 5C. In certain embodiments, the robot 600 comprises twenty-eight actuators 604 Of course more or less than twenty-eight actuators can be employed by the robot 600 and still fall within the scope of this disclosure. In certain embodiments, the number and location of the actuators 604 in any given limb is selected so that the limb achieves six degrees of freedom (e.g., forward/back, up/down, left/right, yaw, pitch, roll).

In certain embodiments, the one or more motors 602 can be electric, pneumatic, or hydraulic. Electric motors may include, for example, induction motors, permanent magnet motors, and so on. In certain embodiments, the one or more motors 602 drive one or more of the actuators 604. In certain embodiments, a motor 602 is associated with each actuator 604.

An exemplary embodiment of a rotary actuator 500 is shown in FIGS. 5E, 5G, and 5I. In some embodiments, the rotary actuator 500 can include a mechanical clutch 502 and angular contact ball bearings 504 coupled to a shaft 506 and integrated on a high speed side 510 of the rotary actuator 500. In some embodiments, the rotary actuator 500 can include a cross roller bearing 512 on a low speed side 520 of the rotary actuator 500. In some embodiments, the rotary actuator 500 can include strain wave gearing 514 positioned between the high speed side 510 and the low speed side 520. In some embodiments, the rotary actuator 500 can further include magnets 516 coupled to an outer surface of the rotor 513. In some embodiments the rotary actuator 500 can also include one or more sensors, e.g., an input position sensor 522 configured to detect angular positions on the high speed side 510 of the rotary actuator 500 and an output position sensor 524 configured to detect angular positions on the low speed side 520 of the rotary actuator 500, and a non-contact torque sensor 518 configured to monitor output torque of the rotary actuator 500.

An exemplary embodiment of a linear actuator 550 is shown in FIGS. 5F, 5H, 5J. In some embodiments, the linear actuator 550 can include planetary rollers 552 positioned on the low speed (or linear) side 560 of the linear actuator 550 and positioned between an actuator shaft 561 of the low speed side 560 and a rotor 574 of a high speed (or rotary) side 570 to provide stability. In some embodiments, the linear actuator 550 can include an inverted roller screw 554 that functions as a gear train between the low speed side 560 and the high speed side 570 of the linear actuator 550 to allow efficiency and durability. In some embodiments, the linear actuator 550 can further include a ball bearing 562 proximate one end of the high speed side 570 of the linear actuator 550 and a 4-point contact bearing 564 proximate another end of the high speed side 570 of the linear actuator 550, both positioned between the rotor 574 of the high speed side 570 and an enclosure 575 of the linear actuator 550. In some embodiments, the linear actuator 550 can also include a stator 572 coupled to the enclosure 575. In some embodiments, the linear actuator 550 can include magnets 566 coupled to an outer surface of the rotor 574. In some embodiments, the linear actuator 550 can also include one or more sensors, e.g., a force sensor 567 attached to a main shaft 580 of the linear actuator 550 and configured to monitor a force on the main shaft 580, and a position sensor 568 attached to the enclosure 575 and configured to detect angular position of the rotor 574.

Batteries 606 can include one or more battery packs each comprising a multitude of batteries may be used to power the electric motors as is known by those skilled in the art. FIG. 5D illustrates a battery pack integrated into a robot 600 illustrating a vertically oriented battery back with protective coverings.

The robot 600 further includes a communication backbone 608 that is configured to provide communication functionality between the processor(s) 610, motors 602, actuators 604, battery components 606, sensors, etc. The communication backbone 608 can illustratively be configured to directly connect the components via a common backbone channel that can form one or more communication loops. Such interaction allows for redundancy and failures in individual components without also causing failures in the ability for other components to communicate.

Additionally, the robot includes the processor system 120 which processes data, such as images received from image sensors positioned about the robot 600. The processor system 120 may additionally output information to, and receive information (e.g., user input).

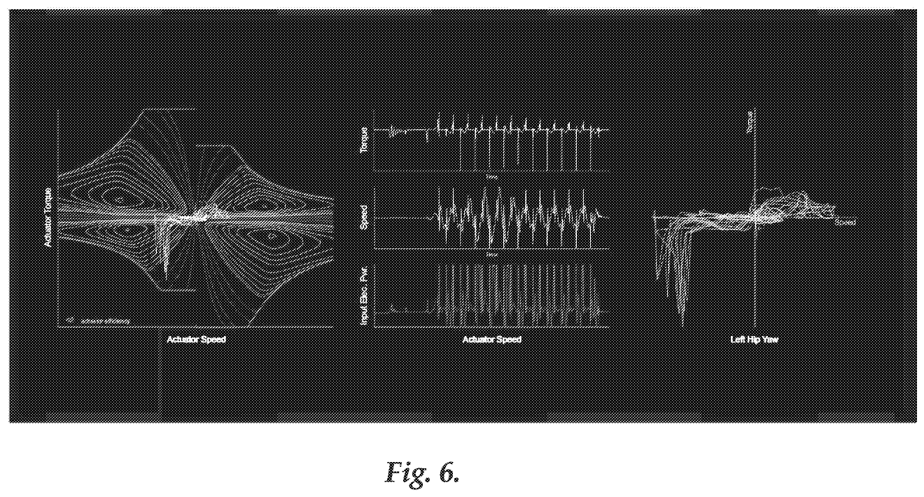

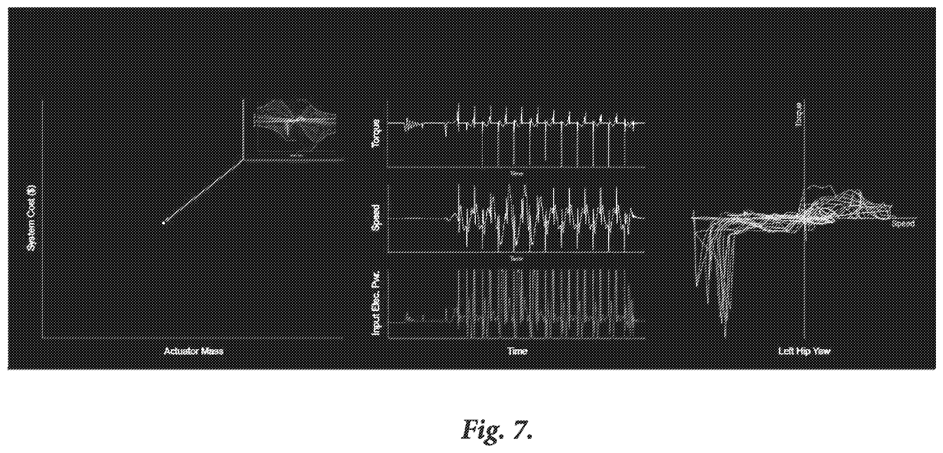

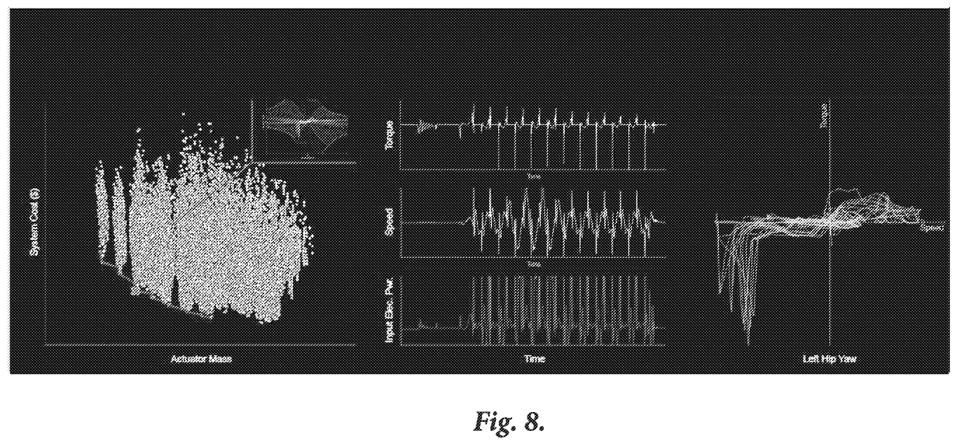

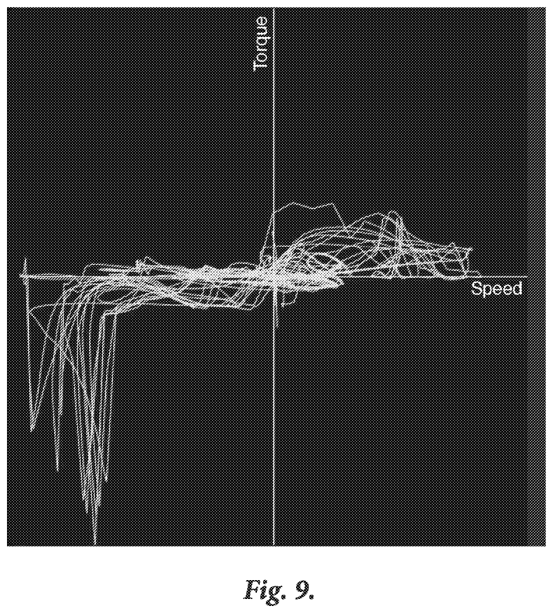

FIG. 6 illustrates targets and methodology for movement of an exemplary actuator 604 (e.g., left hip yaw) illustrated in FIGS. 5B and 5C including actuator torque and speed. FIG. 7 illustrates a single association between the targets and methodology illustrated in FIG. 6 with system cost and actuator mass. FIG. 8 is similar to FIG. 7 but includes a plurality of associations for use to select an optimized design for the actuator. FIG. 9 illustrates performance aspects related to the torque and speed for the movement of the actuator for the joint (e.g., left hip yaw) from FIG. 6.

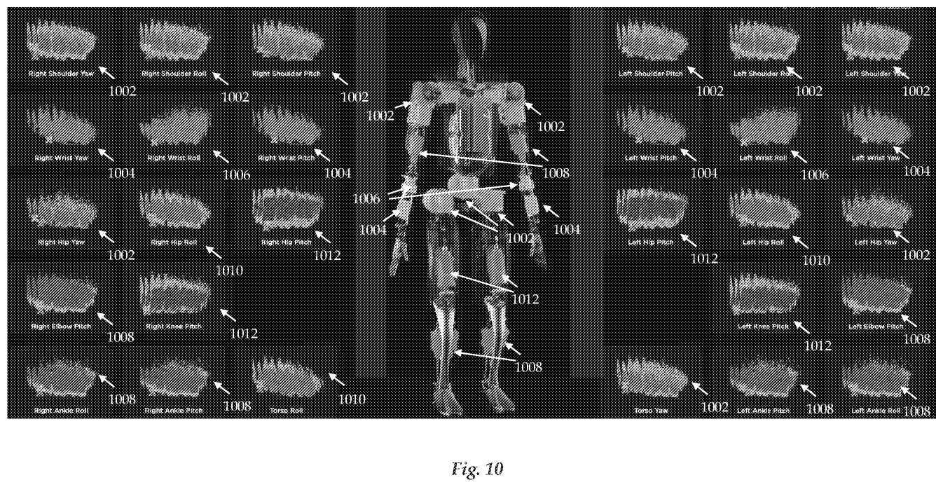

In one aspect, a method of selecting actuators is disclosed herein. As shown in FIGS. 6-9, various analysis can be conducted for each type of movement at each location or joint of the robot 600 to determine what actuator is to be used at each location of the robot 600. As illustrated in FIG. 10, performance graphs (e.g., graphs of system cost) can be created for each type of movement of each location (e.g., right shoulder yaw, right shoulder roll, or right shoulder pitch). In some embodiments, the method of selecting actuators can include creating such performance graphs for a plurality of types of movement of a plurality of locations of the robot 600, and then group the movement types of the various locations by their commonalities. In some embodiments, the performance graphs for the plurality of types of movement of the plurality of locations can be grouped into six types, each corresponds to a different actuator. For example, as illustrated in FIG. 10, an actuator system disclosed herein can include one or more first type of actuators 1002 positioned at torso, shoulder, and hip locations of the robot, one or more second type of actuators 1004 positioned at wrist locations of the robot, one or more third type of actuators 1006 positioned at the wrist locations of the robot, one or more fourth type of actuators 1008 positioned at elbow and ankle locations of the robot, one or more fifth type of actuators 1010 positioned at the torso location and the hip locations of the robot, and one or more sixth type of actuators 1012 positioned at knee locations and the hip locations of the robot.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A system of movement control of a robot using actuators, the system comprising:
one or more first type of actuators positioned at torso, shoulder, and hip locations of the robot;
one or more second type of actuators positioned at wrist locations of the robot;
one or more third type of actuators positioned at the wrist locations of the robot;
one or more fourth type of actuators positioned at elbow and ankle locations of the robot;
one or more fifth type of actuators positioned at the torso location and the hip locations of the robot; and
one or more sixth type of actuators positioned at knee locations and the hip locations of the robot.

2. The system of claim 1, further comprising one or more motors configured to cause movement of the one or more actuators.

3. The system of claim 2, further comprising one or more batteries positioned at the torso location of the robot and connected to the one or more motors.

4. The system of claim 3, further comprising a communication backbone communicatively connected to the one or more actuators and the one or more motors.

5. The system of claim 4, further comprising a processor communicatively connected to the communication backbone.

6. They system of claim 5, wherein the one or more batteries are connected to the communication backbone.

7. They system of claim 5, wherein the communication backbone is configured to allow communication between the processor, the motor, and sensors on the actuators.

8. The system of claim 7, wherein the processor is configured to control the one or more motors and receive information from the sensors on the actuators through the communication backbone.

9. The system of claim 1, wherein one or more of the first type, the second type, the third type, the fourth type, the fifth type, and the sixth type of actuators comprises rotary actuators.

10. The system of claim 9, wherein at least one of the rotary actuators comprises a mechanical latch.

11. The system of claim 1, wherein one or more of the first type, the second type, the third type, the fourth type, the fifth type, and the sixth type of actuators comprises linear actuators.

12. The system of claim 11, wherein at least one of the linear actuators comprises planetary rollers.

13. A method of controlling movement of a robot using actuators, the method comprising:
controlling torso, shoulder, and hip locations of the robot with one or more first type of actuators;
controlling wrist locations of the robot with one or more second type of actuators;
controlling the wrist locations of the robot with one or more third type of actuators;
controlling elbow and ankle locations of the robot with one or more fourth type of actuators;
controlling the torso location and the hip locations of the robot with one or more fifth type of actuators, and
controlling knee locations and the hip locations of the robot with one or more sixth type of actuators.

14. The method of claim 13, further comprising controlling the one or more actuators with one or more motors.

15. The method of claim 14, further comprising providing power to the one or more motors with one or more batteries positioned at the torso location of the robot.

16. The method of claim 15, further comprising communicatively connecting the one or more actuators and the one or more motors with a communication backbone.

17. The method of claim 16, further comprising communicatively connecting the communication backbone to a processor.

18. They method of claim 17, further comprising providing power to the communication backbone with the one or more batteries.

19. The method of claim 19, further comprising controlling the one or more motors and receiving information from the sensors on the actuators with the processor through the communication backbone.

20. The method of claim 13, wherein one or more of the first type, the second type, the third type, the fourth type, the fifth type, and the sixth type of actuators comprises rotary actuators; and wherein one or more of the first type, the second type, the third type, the fourth type, the fifth type, and the sixth type of actuators comprises linear actuators.
